(19) United States
(12) Patent Application Publication
(10) Pub. No.: US 2026/0086111 A1
(43) Pub. Date: Mar. 26, 2026

(54) CANTILEVERED SCANNING PROBE QUANTUM SENSOR AND APPLICATIONS OF THE SAME

(71) Applicant: UNIVERSITY OF MARYLAND, COLLEGE PARK, College Park, MD (US)

(72) Inventors: Huayu Zhang, Hyattsville, MD (US); Min Ouyang, North Bethesda, MD (US)

(21) Appl. No.: 19/331,133

(22) Filed: Sep. 17, 2025

Related U.S. Application Data
(60) Provisional application No. 63/697,872, filed on Sep. 23, 2024.

(51) Int. Cl. G01Q 60/40

(52) U.S. Cl. CPC G01Q 60/40

(57) ABSTRACT

Highly integrated cantilever-based probe employing apparatus configured for scanning-type quantum sensing and imaging of nitrogen-vacancy centers. Optionally, the apparatus may utilize an atomic force microscope hardware. Method for fabricating and operating the same. The as-fabricated cantilever-based probe for use with such apparatus is structured to operate as a microwave antenna and lends itself for various magnetic field imaging, electric field imaging, and thermal imaging with high detection sensitivity and nano-scale spatial resolution.

### CROSS-REFERENCE TO RELATED APPLICATIONS

This patent application claims the benefit of U.S. provisional patent Application No. 63/697,872 filed on Sep. 23, 2024. The disclosure of which is incorporated by reference herein.

### TECHNICAL FIELD

The present invention relates to scanning quantum sensors and, more particularly, to quantum sensors employing a cantilevered probe configured to operate as a microwave antenna.

### RELATED ART

Diamond, as a material, is a good conductor of heat with a small thermal expansion coefficient. It is also a good insulator with high refractive index and dispersion coefficient. In addition, diamond has a high forbidden band of 5.5 eV and high transparency from infrared to ultraviolet. All of these characteristics make diamond an excellent candidate for optical quantum information processing. Single-crystal diamonds can be grown with high-pressure high-temperature (HPHT) or chemical vapor deposition (CVD) methods, as known in the art.

Nitrogen-vacancy (NV) center represents a photostable fluorescent atomic defect in a diamond material with unique magneto-optic effects. FIG. 13A shows the lattice structure of a single NV center, which includes a nearest neighbor pair of a substitute nitrogen atom and an atomic vacancy. Due to the face-centered cubic (FCC) structure of the diamond lattice and the C3v symmetry of the NV centers, there are only four possible orientations of the NV color centers in bulk diamond. The angle between the symmetry axis of the diamond structure and other C—N bonds is 109.47°. As a result, once the orientation of diamond host is fixed, four possible orientations of NV center confined inside are also determined, which is essential for using NV centers for quantum sensing. Particularly, when diamond hosts become very small at the nanoscale, named nanodiamonds (NDs), the NV centers confined inside can be exposed to the environment with a very close distance to facilitate effective quantum sensing and imaging due to the small dimension of NDs. Furthermore, the properties of NV centers in a ND can be also engineered by surface functionalization of ND and coupling ND host with external functional nanostructures.

The NV center can be naturally formed in a diamond. As known in related art, such NV center can also be created with techniques utilizing ion implantation followed by high-temperature (typically, >1000 K) annealing. Two charge states of an NV center—the neutral NV center (NV⁰) and the negatively charged NV center (NV⁻)—are known from spectroscopic studies performed with the use of optical absorption, photoluminescence (PL), electron paramagnetic resonance (EPR), and optically detected magnetic resonance (ODMR). The NV⁰ contains 5 electrons with the total spin quantum number of S=½, while the NV⁻ contains 6 electrons with the total spin quantum number S=1. The energy level diagram is shown in FIG. 13B, where |g [symbol] represents the electronic ground state, |e [symbol] represents the excited state, and |s [symbol] represents an unstable singlet state. The energy level separation between the mₛ=0 and mₛ=±1 is 2870 MHz. The conversion of the two charge states of the NV center can be achieved by means of an external electric field or laser pulses for example. Since signals from the ground state of the NV⁰ is too broad for EPR detection, the NV⁻ is often used in experiments. The energy level structure of the negatively charged NV center is stable, non-toxic, and has a relative long coherence time at room temperature, making it a good single-photon source. The Hamiltonian of an NV center in a diamond host is sensitive to local magnetic, electric field, temperature and strain, making it an ideal candidate for atomic scale quantum sensing that can find useful in a variety of research fields in the science and technology (see, for example, Ann. Rev. Phys. Chem. 2014; 65-: 83-105). For example, in the presence of magnetic field, the energy level of mₛ=±1 is split into two (sub) levels with an interval of 2γB due to the Zeeman effect, where γ=2.8 MHz/Gauss represents the coefficient of magnetic field sensitivity, and B is the magnetic field along the NV axis. As is known in related art, the NV centers confined in an ND host can be exposed to the environment with a very close distance to facilitate effective quantum sensing and imaging due to the small dimension of NDs. Furthermore, the properties of NV centers in an ND can be also engineered by surface functionalization of ND and coupling ND host with external functional nanostructures.

One application of an NV center stems from a combination of such NV center with a scanning probe microscope to arrive at a scanning quantum sensor. Currently, there exist two different techniques for fabricating scanning NV center probes, including a commercialized method according to which diamond nano-pillars, which are etched from a bulk single-crystal diamond, are glued to a scanning probe of an appropriate microscope to arrive at a scanning NV centers probe (see, for example, Nature Nanotechnology, 7, 320-324, 2012; Rep. Prog. Phys., 77, 056503, 2014, among others). Such NV scanning probes can be robust as well as having long spin coherence time, and the associated density and depth of NV centers can also be controlled by tuning ion implantation energy; the process of manufacture of such probes, however, remains complicated and expensive. Further, the practice proved that precise control of a number of NV centers in each resulting tip of a scanning NV center probe. Furthermore, in order to use such tip for quantum sensing and imaging, a spatially separate and distinct microwave antenna has to be fabricated and used in conjunction with the use of the top of the scanning NV center probe, thereby limiting the usage of the overall resulting probe system.

The other-second-method to fabricate an NV centers based scanning probe discussed in literature is to graft an ND (containing NV centers) to the apex of a tip of a scanning probe of a chosen microscope (in a non-limiting case—to the apex of a cantilevered probe of an atomic force microscope, or AFM; in another non-limiting ae—to an optical fiber based probe of a near-field scanning optical microscope of NSOM) by using either van der Waals force between the ND and tip or electrostatic force through functionalization of poly-lysine molecules to the tips (which are generically not robust for practical applications; here, a reader is referred to, for example, Appl. Phys. Lett. 100, 153118, 2012; or Optics Express, 17, 19969-19980, 2009, for example). Just like in the first method alluded to above, currently the presence and use of (an external to and spatially separate from the device equipped with the probe) microwave antenna remains necessary in order to operate with NV centers. Furthermore, this second methodology is based on topographic features to facilitate picking up NDs randomly instead of using optical features, thus making fabrication process less reproducible and reliable.

There remains an unsatisfied need in a methodology of reliable fabrication and use of a probe that can be used to realize a compact scanning quantum sensing apparatus.

### SUMMARY OF THE INVENTION

Embodiments of the invention provide an article of manufacture that includes a cantilevered probe having a cantilever and a tip at a proximal end of the probe and structured to operate as a microwave antenna and configured to be operably connected to a microwave generator system. In at least one implementation, such article is configured to modulate a microwave signal produced by the microwave generator system and to couple a modulated microwave signal to the cantilevered probe. Optionally, in at least one specific implementation, an apex of the tip of the cantilevered probe may carry a material containing a source of photoluminescent light; and/or the tip of the cantilevered probe may carry thereon a layer of adhesive containing a dye. Alternatively or in addition—and substantially in every embodiment—the article of manufacture (i) may be configured to deliver first light, generated by a first source of light, to the proximal end and optionally include such first source of light optically coupled with the proximal end of the probe (for example, with the space including the tip of the probe and the immediately surrounding space), and/or (ii) may be configured to deliver second light, generated by a second source of light, to the cantilever to detect a deflection of the second light off of (or from) the cantilever and optionally include such second source of light. Alternatively or in addition—and substantially in every implementation—that article may include an optical detection system that includes an optical detector, and at least one optical system that is configured to receive first optical radiation from the proximal end of the cantilevered probe to form an optical image, in said first optical radiation, at a surface of the optical detector and/or that is configured to receive the second optical radiation delivered in reflection from a cantilever of the cantilevered probe to register angular deviation of a beam of the second optical radiation in time. Optionally, the article may further include a sample stage configured to support a target sample in a repositionable spatial relationship with respect to the cantilevered probe to enable subjecting the target sample to excitation microwave radiation produced at the cantilevered probe and/or a support structure configured to secure a distal end of the cantilevered probe therein (generally—a hardware frame; and in a non-limiting case, such support structure may include at least a part of hardware of a scanning force microscope such as an AFM, for example). Furthermore, the article may contain a scanning force microscope apparatus configured to accept the cantilevered probe therein and to operate with the use of the cantilevered probe.

Embodiments of the invention additionally provide a method performed with the use of substantially every embodiment of the article of manufacture alluded to above. Such metho includes at least one of the following steps: (i) forming an image of a nitrogen vacancy (NV) center contained in a single-crystal piece of nanodiamond (ND) with the use of photoluminescent light produced by the single-crystal piece of ND and (ii) determining an orientation of the NV center in the single-crystal piece of ND. Optionally, the method may include a process of assessing an orientation of the NV center contained in the single-crystal piece of ND (that has been affixed to the tip of the cantilevered probe) with respect to a chosen axis at least in part by performing the following steps to determine optically-detected magnetic resonance characteristics of the NV center for at least one of a first magnetic field and a second magnetic field: step (a): determining a zero-magnetic-field signal representing an optically-detected magnetic resonance of said NV center during a process of detecting a first photoluminescence signal (a first photoluminescent light) generated at the NV center while modulating a microwave or microwave signal generated at the cantilevered probe and applied to the NV center in absence of a magnetic field, and step (b): applying at least one of the first magnetic field and the second magnetic field to the NV center with first and second magnets, respectively, and collecting a second photoluminescence signal (second photoluminescent light) generated at the NV center while modulating the microwave generated at the cantilevered probe and applied to the NV center. Here, such magnets are configured (i) to change a spatial orientation of at least one of a first vector of the first magnetic field and a second vector the of the second magnetic field and/or (ii) to vary respective strengths of the first and second magnetic field. (In at least such a case, the method may include repeating the steps of applying and collecting for multiple orientations of the at least one of the first magnetic field and the second magnetic field applied to the NV center to determine respectively-corresponding multiple optically-detected magnetic resonance characteristics.) Alternatively or in addition—and prior to the step of forming the optical image and/or the step of determining the orientation of the NV center—the method may include a step of affixing the single-piece of the ND to the tip of the probe (for example—an apex of the tip) with the use of an adhesive that includes a dye and that is carried by the tip. Alternatively or in addition—and substantially in every implementation—the method may include (prior to the step of forming the optical image and/or the step of determining the orientation of the NV center) a step of causing an electrically-conducting layer of the tip of the cantilevered probe to become hydrophilic. In at least one embodiment where the article of manufacture includes an optical imaging system (for example, an optical camera), the method may include a step of substantially spatially aligning a first optical image (formed with the optical imaging system in photoluminescent light emanating from the single-crystal piece of the ND affixed to the tip) with a second optical image (formed with the optical imaging system in optical radiation that is produced by a chemical substance carried by the tip of the cantilever probe). Optionally, in at least one specific embodiment the method may include (i) operably connecting an electrically-conducting portion of the cantilever probe to the microwave generator; (ii) choosing the single-crystal piece of the ND from a multiplicity of single-crystal pieces of the ND based on characterizing at least an NV center contained therein (here, the characterization is performed with the use of the cantilevered probe); (iii) affixing the chosen single-crystal piece of the ND to the tip of the cantilevered probe; and (iv) activating the microwave generator to manipulate a spin of the NV center with a microwave emanating from the electrically-conducting portion of the cantilever probe. (In such a case, the characterization may include determining an intensity of photoluminescent light produced by the at least one NV center and/or using an auto-correlation measurement).

Embodiments of the invention additionally include a computer program product for use on a computer system for characterizing and/or imaging of a color center of a material particle, the computer program product comprising a computer usable tangible non-transitory storage medium having computer readable program code thereon, the computer readable program code including program code for performing steps of any and every embodiments of the method alluded to above.

Embodiments of the invention further provide a method that is performed with a cantilevered probe configured to operate as a microwave antenna (in one non-limiting case—with the use of a cantilevered probe configured for use with a scanning force microscope such as an AFM). The method includes emitting an electromagnetic wave by or at the cantilevered probe, and characterizing a piece of a diamond material and/or manipulating a physical characteristic of the piece of the diamond material with the use of such electromagnetic wave. Optionally, the method may include a step of coating the cantilevered probe with an electrically-conducting material layer and/or configuring an electrically-conducting material layer present on a tip of the cantilevered probe to operate as the microwave antenna. Alternatively or in addition—and substantially in every implementation—the method may include: operably connecting an electrically-conducting portion of the cantilevered probe to a microwave generator; mounting the piece of the diamond material at a tip of the cantilevered probe with an adhesive; and activating the microwave generator to manipulate a spin of a color center of the piece of the diamond material with a microwave emanating from the electrically-conducting portion of the cantilevered probe. (In such specific case, the step of mounting may include a step of substantially aligning a first optical image formed with the use of an optical imaging system such as e.g. an optical camera in photoluminescent light emanating from the piece of the diamond material, with a second optical image that is formed in optical radiation produced by a chemical substance carried by the tip of the cantilevered probe; and/or the step of mounting may include a step of sticking the piece of the diamond material to the tip—e.g. an apex of the tip—of the cantilevered probe with the use of an adhesive that is carried by the tip and that includes a dye.) Furthermore, in at least one specific embodiment the method may include a judicious step performed prior to the step of characterizing and/or the step of manipulating: such judicious step include pre-treating an outer layer of the tip of the cantilevered probe to make an outer layer thereof exhibit hydrophilic properties. Optionally, the step of characterizing and/or the step of manipulating may be carried out while the cantilevered probe is transmitting a microwave signal. Optionally, an embodiment of the method may include collecting photoluminescent light, generated at the piece of the diamond material in response to having such piece of the diamond material irradiated with excitation light. Optionally, the piece of the diamond material may include a single-crystal piece of nanodiamond (ND), while the step of characterizing includes forming an image of a nitrogen vacancy (NV) center contained in the single-crystal piece of ND with the use of photoluminescent light produced by such single-crystal piece of ND and/or determining an orientation of the NV center in the single-crystal piece of ND. Alternatively or in addition—and substantially in every implementation of the method—the step of characterizing may include assessing an orientation (in reference to a chosen axis) of the NV center in a single-crystal piece of ND that has been affixed to an apex of the cantilevered probe. (Here, the assessing is carried out—to determine optically-detected magnetic resonance characteristics of the NV center for at least one of a first magnetic field and a second magnetic field—at least in part by: (a) determining a zero-magnetic-field signal representing an optically-detected magnetic resonance of the NV center during a process of detecting a first photoluminescence signal generated at the NV center while modulating a microwave applied to the NV center in absence of a magnetic field; (b) applying at least one of the first magnetic field and the second magnetic field to the NV center with first and second magnets and collecting a second photoluminescence signal generated at the NV center while modulating the microwave emitted by the cantilevered probe and applied to the NV center. The first and second magnets are judiciously configured to change spatial orientation of at least one of a first vector of the first magnetic field and a second vector the of the second magnetic field and/or to vary respective strengths of the first and second magnetic fields. Optionally, the steps of applying and collecting may be repeated for multiple orientations of the at least one of the first magnetic field and the second magnetic field applied to the NV center to determine respectively-corresponding multiple optically-detected magnetic resonance characteristics.) Alternatively or in addition, and substantially in every implementation of the method, the step characterizing and/or the step of manipulating may include changing a direction of propagation of a beam of light reflected off of or by the cantilevered probe secured in a hardware of a scanning force microscope or in a hardware of a dedicated support structure.

### BRIEF DESCRIPTION OF THE DRAWINGS

The invention will be more fully understood by referring to the following Detailed Description of Specific Embodiments in conjunction with the Drawings, of which:

FIG. 1 is a schematic illustrating an embodiment of a highly integrated cantilever-based NV center(s) scanning probe configured, according to the idea of the invention, to operate as scanning quantum sensor.

FIGS. 2A and 2B provide SEM images of: FIG. 2A: an uncoated commercially available Si cantilevered probe, and FIG. 2B: gold-coated Si cantilevered probe.

FIGS. 3A-3C. FIG. 3A: A setup for coating a glue layer and grafting an ND particle onto the apex of a cantilevered probe. FIG. 3B: Image of the cantilevered probe (in this specific case—the one of the AFM) and a spot of laser light in reflection off of the probe employed for feedback signal. FIG. 3C schematically illustrates the process of choosing the target single-crystal piece of ND and affixation of such piece at the tip of the cantilevered probe to form an embodiment of a probe of the invention.

FIGS. 4A, 4B, 4C, and 4D provide SEM images of UV glue coated on the tip apexes of cantilevered probes under different conditions. Scale bar, 2 μm. FIG. 4A: No hydrophilic treatment was applied to the metallized tip of the probe. FIG. 4B: UV glue picked up from the spin-coated UV glue layer. The dark area represents the area covered with glue due to charging. FIG. 4C: UV glue picked up from evaporated UV glue dissolved in HPLC acetone. FIG. 4D shows the desired result of spatially limiting the thin glue layer to only the apex of the hydrophilic tip of the cantilevered probe as a result of controlling the glue layer thickness on substrate.

FIGS. 5A, 5B, 5C, and 5D shows a series of optical images illustrating the process of alignment of the image formed in photoluminescence (PL) emanating from the dye mixed-up with the portion of adhesive attached to the apex of the cantilevered probe with that produced by emission emanating from NV center(s) in a piece of ND during the engaging of the piece of ND by the top of the probe.

FIG. 6 is a schematic diagram of an optical setup structured to determine orientation(s) of NV center(s) of the ND-component of an embodiment of the cantilevered NV center(s) scanning probe (indicated as sample, on the sample mount) of FIG. 1.

FIGS. 7A-7C. FIG. 7A: A schematics of processing of a PL signal received from the NV centers of a ND portion of the embodiment of the cantilevered NV centers probe and the delivery of a microwave (MW) signal to the embodiment of the probe (or, alternatively to a chosen external antenna). FIG. 7B: Image showing a PCB board containing an embodiment of a cantilevered (cantilever-based) NV centers probe structured according to the idea of the invention and, etched in the same board, an external and separated from the embodiment of the invention loop microwave antenna to which microwave signals (MW signals) are delivered through a coaxial cable to assist in determination of orientation of the NV centers of the embodiment of the probe (stated differently—to assist in calibration of NV orientations of the ND-portion of the embodiment of the probe). FIG. 7C: Image of a custom optoelectronic setup for determination of orientation of NV centers.

FIGS. 8A-8D. FIG. 8A: Image of a custom 3D vector magnet setup. FIG. 8B: a schematic representing arrangement of horizontal and vertical magnets in the setup of FIG. 8A. FIGS. 8C, 8D: Plots displaying strengths of vertical and horizontal magnetic fields as functions of a sample distance.

FIGS. 9A-9C. FIGS. 9A, 9B: FEM simulation of electric field and magnetic field distributions (in log-scale) above the external loop microwave antenna (used in a specific case for determination of orientations of NV centers of the NFD portion of the embodiment of the probe), respectively. FIG. 9C: FEM simulated S11 parameter of the external loop microwave antenna.

FIGS. 10A-C. FIG. 10A: plots of intensity of collected ODMR (lower curve) as functions of a frequency of microwave generated at an embodiment of the cantilever-based NV center probe in the presence of horizontal a magnetic field with different orientations: 0°, 60°, 90° and 120° from left to right, respectively. Upper curves represent intensity of photoluminescence produced at the NCV centers of the probe. FIG. 10B: Resonant frequencies of four different sets of NV centers. Dots: experimental values; Curves: calculated data. FIG. 10C: A plot of calculated four NV orientations in the spherical coordinates, the z-axis is the symmetry axis of the tip of the cantilevered probe (see 350 in FIG. 3C).

FIGS. 11A-11D. FIGS. 11A, 11B: SEM images of an embodiment of a cantilever-based ND probe structured according to the idea of the invention immediately after fabrication and after 5 hrs continuous scanning imaging (with the use of AFM hardware), respectively. Scale bar: 500 nm. FIG. 11C: An AFM image acquired with the use of the embodiment of the probe of FIG. 11A. FIG. 11D: Optical image of photoluminescent emission (identified by the arrow PL) of NVs of the cantilever-based probe of FIG. 11A. Scale bar: 5 μm.

FIGS. 12A-12B. FIG. 12A: Image of a metal coaxial wire glued to the base of cantilevered probe with gold thin film coating by using conductive silver paste. FIG. 12B: The ODMR spectrum of NV center(s)_present at a piece of ND on the apex of the cantilevered probe and excited by the microwave coupled through the metallic coating on the cantilevered probe as shown in FIG. 12A. Also, the intensity of photoluminescence emitted by the NV center(s).

FIGS. 13A-13B. FIG. 13A depicts a schematic of the lattice structure of a single NV center. FIG. 13B presents an energy level diagram of the single NV center.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another. Drawings are generally not to scale.

### DETAILED DESCRIPTION

A problem of inability of related art to enable scanning quantum sensing of color centers present in a material of choice (such as, for example, of atomic defects formed in a diamond by nitrogen-vacancy centers) with the use of substantially any version of a conventional cantilevered prove—such as, for example, a cantilevered probe structured for the use with a scanning force microscope—in absence of a separate microwave antenna component or a separate, additional microwave antenna utilizing device—is solved by configuring a monolithic single-piece quantum sensing probe to incorporate a microwave antenna at or within or integrated with the cantilevered probe.

An embodiment of the invention on the one hand enables the use of substantially each and every type of a cantilevered probe for scanning quantum sensing applications while also removing the need of a spatially independent and stand-alone microwave antenna during the process of scanning quantum sensing. The idea of the invention stems from the realization that enabling a cantilevered probe to operate simultaneously as a microwave antenna and as a probe allows the user—upon determining the orientation of the target color center—to perform spin manipulation of the target color center required for quantum sensing with the use of the microwave antenna integrated at the cantilevered probe.

Notably, in stark contradistinction with a conventional probes used for quantum sensing, the cantilevered probe that is structured to include an outer electrically-conducting layer is operably connected with a microwave signal generator to operate the probe in a microwave antenna regime and, optionally, complemented with a layer of adhesive the material composition of which is judiciously chosen to enable the adhesive to operate as a source of light used in the process of affixation of a material particle containing the target color center to the probe. In some specific implementations, an embodiment of the microscope apparatus utilizing such probe may additionally include a magnetic field generator including one or more permanent magnets (or electro-magnets, as an option) configured to apply corresponding magnetic fields to a chosen location (where the target color center may be positioned).

Further, while the existing implementations of the quantum sensing methodologies rely on investigating a bulk version of the diamond crystal, the proposed implementation is specifically enabled to operate with the use of a single nanodiamond particle (and, even more preferably—with the use of a single-crystal single nanodiamond particle) used as a host of at least one color center (or possibly multiple color centers), thereby reducing significantly the overall costs of the scanning quantum sensing procedure. Operation with the host of multiple color centers is preferred due to expected higher signal-to-noise ratio.

The term “cantilevered probe” is defined to refer to a probe element that includes a cantilever and a tip at a proximal end of the cantilever and that is configured to be secured, at its distal end, in an appropriate support frame or a scanning force microscope hardware and containing a cantilever and a tip integrated with the cantilever near a free end thereof.

### Section 1: Fabrication of a Cantilevered NV Center(s) Scanning Probe.

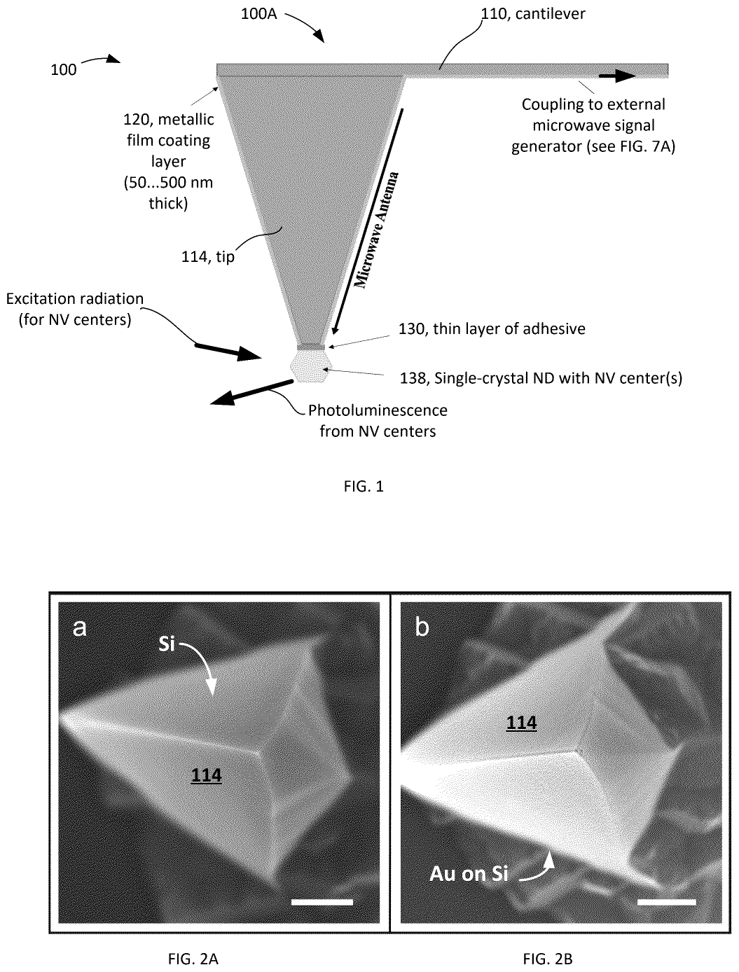

FIG. 1 schematically illustrates an embodiment 100 of the cantilevered probe structured according to the idea of the invention. The embodiment 100 has a cantilevered member 100A with cantilever 110 and a tip 114 and uniquely integrates a component configured to operate as a microwave antenna for quantum sensing and imaging—here, the metallic coating layer 120 carried at least by the tip 114 and extended to be connected to the microwave signal generator (not shown). The tip 114 carries a piece of a diamond material (as shown—a single-crystal piece of a nano-diamond, ND, 138 that is affixed to the tip 114 with the use of an adhesive 130 and that includes at least one NV center). The embodiment of the cantilevered probe 100 lends itself to operation as a scanning quantum sensor. An embodiment of the probe may be interchangeably referred to as a cantilever-based NV center probe. Once an embodiment of the probe is fabricated, optical excitation of NV centers in the piece of a diamond material (with the use of the appropriate excitation radiation) and detection of photoluminescence PL generated at the NV center(s) can be achieved with the use of appropriate optics to deliver the excitation radiation and an appropriate optical imaging system configured to collect the PL. Modulation of NV's PL can be achieved via tuning the microwave, emanating from the embodiment 100, by operating the microwave signal generator.

At the first step of fabrication of the embodiment 100, substantially any commercially available cantilevered member (such as a commercially available cantilevered AFM probe, for example) can be used as the member 100A and be either judiciously coated with a metallic layer 120 (if the initial cantilevered probe does not carry such a metallic layer) or taken with the metallic layer already present without any additional processing. (As the skilled artisan is likely aware, generally there are two different types of cantilevered probes: one has metallic thin film (typically, including Au, Pt, and Al) coating on the tip side of the probe, and the other—a silicon probe without metallic coating.) When the metallization of the initial probe is required, a metallic thin film coating with a thickness from about 50 nm to about 500 nm is judiciously deposited at least at a surface of the tip 114 and appropriately electrically extended (with an electrically conducting member, which may be also optionally configured as a metallic thin film coating) to be connected to an external microwave signal generator when required. Different metals can be used for such thin films, including for example Au, Ag, Pt, or Al.

FIGS. 2A, 2B present scanning electron microscope (SEM) images of a tip of a Si cantilevered AFM probe before and after a 100 m thick Au thin film coating was deposited thereon by sputtering.

At the following step of fabrication of the embodiment 100, a piece of a diamond material, the particles of which are spread on the supporting substrate or surface, is judiciously picked up by the tip and affixed to the tip to be characterized.

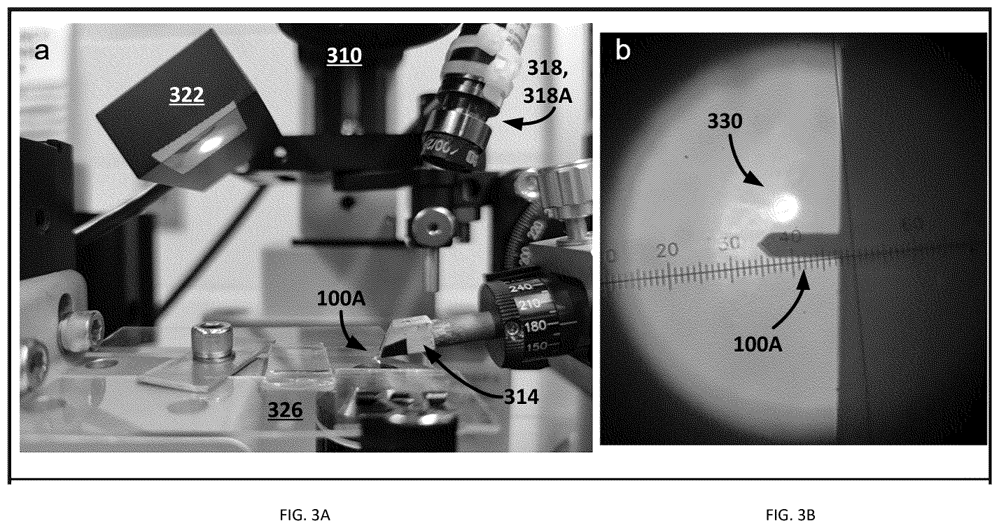

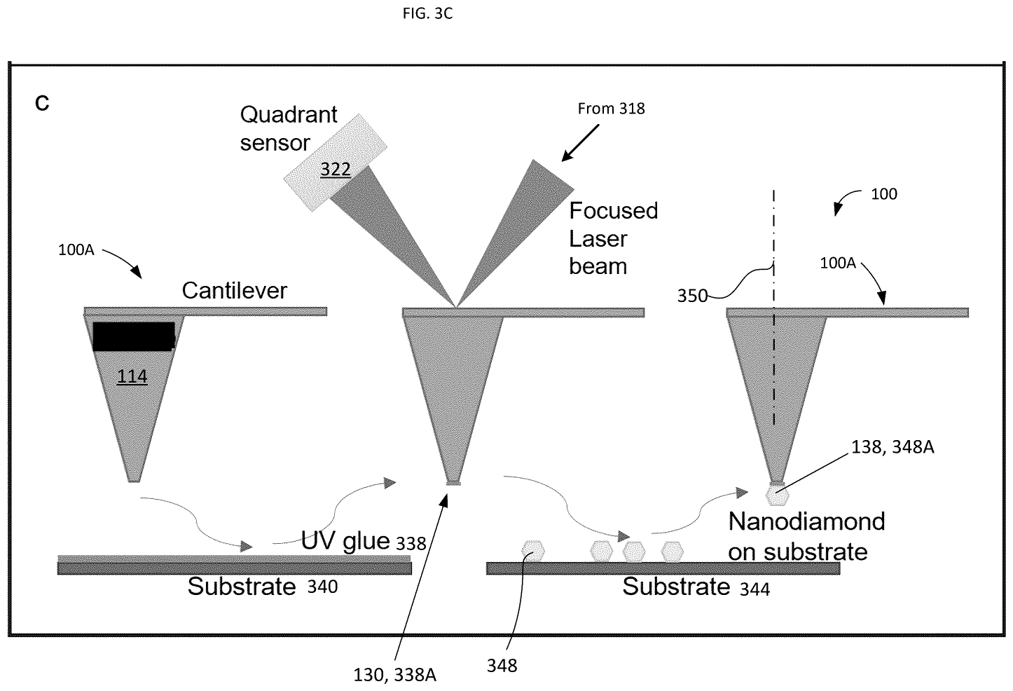

In reference to FIG. 3A, the main setup configured for such process of picking up and affixation, which can be overseen with the use of a microscope 310 (such as an Olympus IX71 microscope) for example, a cantilevered AFM probe of FIG. 2B is shown mounted to or at an appropriate frame. The frame in this case is represented by a machined aluminum block 314 that is intentionally cut at an angle (as seen) to avoid blocking the beam of laser light (not seen in FIG. 3A) delivered from the laser source 318 to the cantilever of the member 100A and, in reflection off of the cantilever—to the position sensor 322 (in one specific case—a quadrant optical detector such as Thorlabs PDP90A) to provide optical feedback representing a spatial orientation of the member 100A. To more precisely monitor whether the probe touches the supporting substrate 326, an appropriate electronic feedback system was constructed as known in the art (a feedback system of a commercially available AFM apparatus provides a typical example). A 405 nm wavelength laser source 318 (here—a laser pointer) equipped with an objective lens 318A having an adjustable focal distance is mounted on the same translation stage as the block 3109 and the member 100A so it can move together with the probe while the probe is engaging or moving in a plane substantially parallel to the surface of the substrate 326.

An independent spatial (micro)positioner device was used to adjust the separation between the focus spot of the laser beam produced by the source 318 and the member 100A to align the laser spot on or at the cantilever under the microscope 310. FIG. 3B shows a microscope image of the focal spot 330 of the feedback laser beam and the cantilever of the member 100A. The feedback beam of laser light aligned with the cantilever 110 is then reflected to the position sensor 322. The skilled person will readily appreciate that—when the member 100A, in its repositioning along an axis transverse to the surface of the substrate 326, contacts the substrate 326—the cantilever 110 bends, and the position of the reflected beam spot on the detector 322 changes and cold be detected with a substantially nanometer-precision with the use of a judiciously constructed electronic feedback circuitry.

In reference to FIG. 3C, the sequence of steps of the procedure for a piece of diamond material pick-up with the tip 114 and the affixation of the picked-up piece of the diamond material to the tip 114 is now described. In this example, a multiplicity of nano-diamond (ND) particulates was spread on the surface of the substrate 326.

The tip 114 of the cantilever (in particular, the apex of the tip 114) was covered or coated with a thin layer of adhesive (such as, for example, a UV glue known in the art). FIG. 3C shows an embodiment of a setup for adding a thin layer of such adhesive to the apex of the tip 114 of the member 110A by slowly engaging the cantilevered probe on a 2 μm thick Norland NOA81 UV glue layer 338 on the cover glass substrate 340 while monitoring the reflected feedback laser position during engaging. (Mentioning it ahead of time, in order to help locating a position of an apex of the tip 114 of the probe during the following characterization, a small amount of rhodamine-6G (or another appropriate dye) was added to the glue solution to help locate the position of the probe apex in later step. The rhodamine-6G could be bleached with a high-power laser beam after the UV glue was cured (in one case, by focusing a 10 mW of laser power produced by a 520 nm wavelength laser on the tip end for about 10 minutes) to cease the ability of the dye to generate luminescence thus bring the background photoluminescence to a level below that produced by a single NV center of the piece of ND affixed to the tip 114 to reduce background noise during optical measurements.)

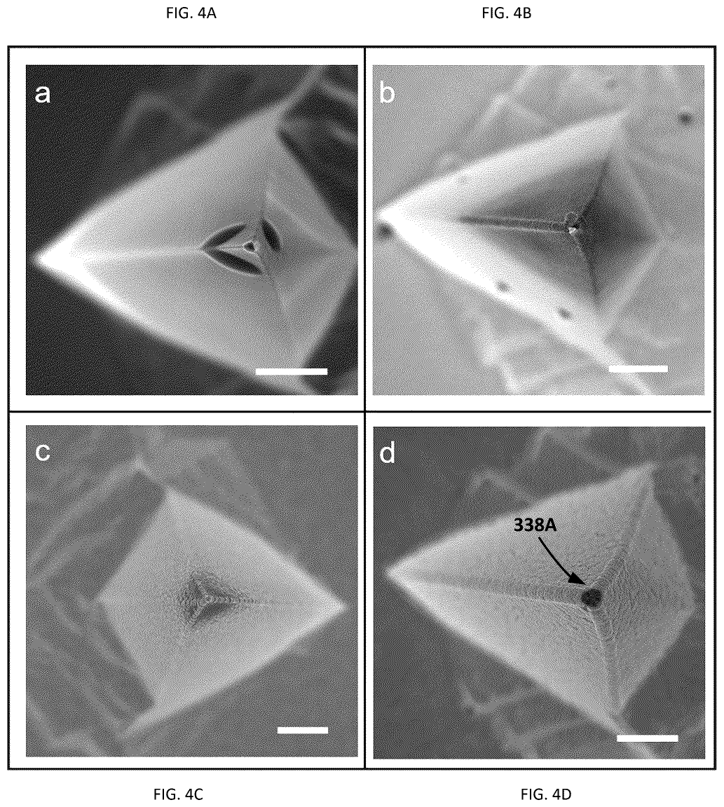

To facilitate coating of the the tip 114 with a thin UV glue layer, the gold coating pre-formed on a surface of the tip (see FIG. 2B) was judiciously treated to become hydrophilic to avoid formation of a droplet of the UV glue on the tip. The thickness of the glue layer on the substrate 340 was also found to be substantially critical for coating only the apex of the tip 114—and not the side surfaces of the tip—with the UV glue portion 338A. Typically, the thinner glue layer 338 on substrate 340 was, the less glue was attached to the tip apex. FIGS. 4A through 4D illustrate the results of the coating of the tip of the cantilevered members 100A with the UV glue under different conditions. Scale bar, 2 μm. FIG. 4A: No hydrophilic treatment was applied to the metallized tip of the probe, as a result of which several droplets (dark areas) of UV glue formed on different surfaces of the metallized tip 114. FIG. 4B: UV glue picked up from the spin-coated UV glue layer. The dark area represents the area covered with glue due to charging. FIG. 4C: UV glue picked up from evaporated UV glue dissolved in HPLC acetone, coating pyramidal surfaces of the tip next to the very apex as well as the apex. FIG. 4D shows the desired result of spatially limiting the thin glue layer to only the apex of the hydrophilic tip of the cantilevered member 100A as a result of controlling the glue layer thickness on substrate.

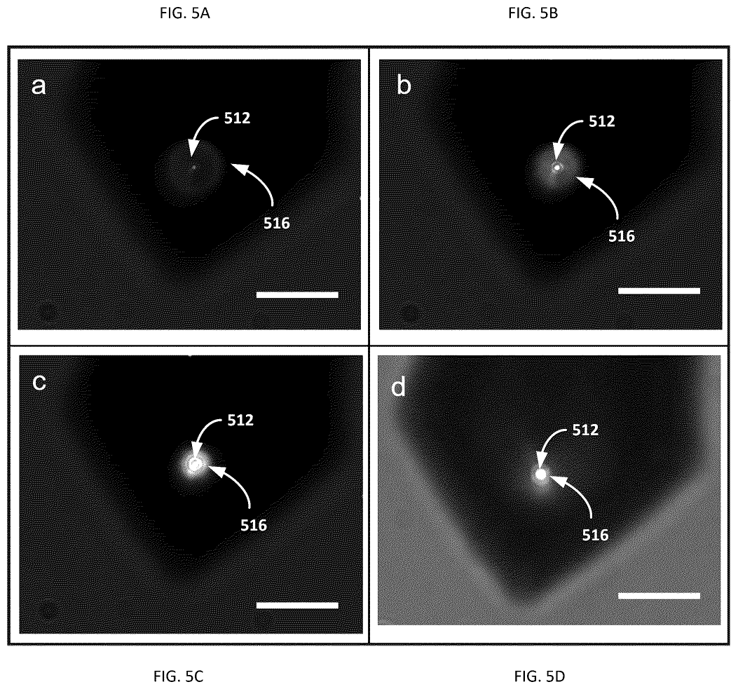

Referring again to FIG. 3C and further to FIGS. 5A through 5D, as part of the procedure, the suspension of ND particles in deionized water was spin-coated on an acid-cleaned fused-silica supporting substrate 344, and a single piece of a ND material 348 was picked up by and affixed to the coated-with-the-adhesive 338A tip 114 while spatially aligning the optical image 512 produced by weak photoluminescence signal emanating from the dye in the glue portion 338A at the probe apex with the image 516 of the photoluminescence produced by a given piece of ND 348 under the optical camera monitoring. A sudden increase in the ND photoluminescence can be observed when the ND is attached to the tip 114/adhesive 338A.

After pre-selected piece of ND 338A with NV center(s) is picked up and glued to cantilevered probe, the process of fabrication of an embodiment 100 of the invention is completed. The axis 350 indicates the axis of the tip 114. Now orientation(s) of NV center(s) confined inside the single-piece ND 338A needs to be characterized and determined before the embodiment 100 can be successfully used in a quantum sensing application.

### Section 2: Determination of Orientation of NV Center(s) in an Embodiment of the Probe.

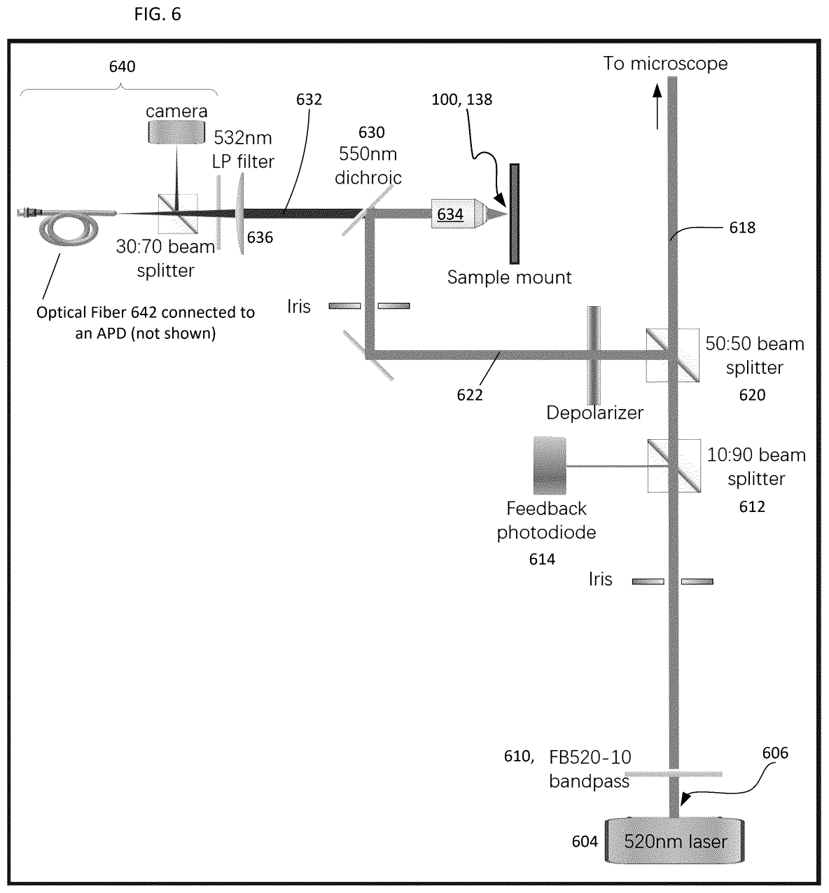

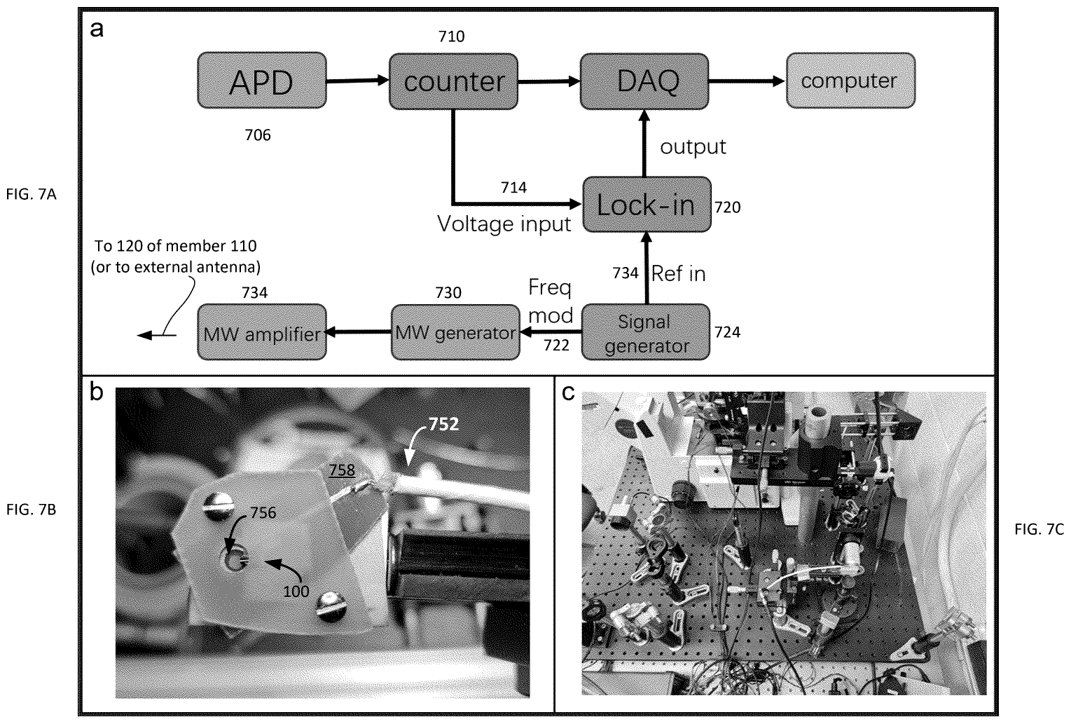

FIG. 6 shows a schematic of optical setup for determining orientations of NV centers of the single-piece of ND 138, 348A of the embodiment of the probe 100, while FIGS. 7A through 7C illustrate a NV center photoluminescence signal detection scheme (employed in conjunction with the setup, where a portion of the scheme identifying an optional use of an external to the embodiment auxiliary antenna, here—loop antenna), and the image of the overall setup, respectively. Here, a 520 nm wavelength laser diode 604 with a maximum output power of about 100 mW was used as a laser source of excitation radiation both for picking up a single-piece ND 138, 348A and for characterizing such piece of ND. The output laser beam 606 was first transmitted through a bandpass filter 610 (Thorlabs FB520-10) to remove the spectral sideband(s) of the laser diode's output and tapped at beam splitter 612 to deliver about 1/10 of the output power to a DET-200 photodiode 614 to provide feedback information about the output power. The feedback current, generated by the photodiode 614, was looped back to the input of the controller of the laser power of the source 606. A portion 618A of the radiation of the beam 606 was redirected, at the beam splitter 620, to the microscope 310 of FIG. 3A (used for attachment of the single-piece ND 348A to the apex of the tip 114 of the probe 100). The remaining portion 622 of the beam 606 was directed to a depolarizer (Thorlabs DPP25-A) and then off of a long pass dichroic mirror 630 (Thorlabs DMLP550) into the objective lens 634 and towards the ND piece 138, 348A. The depolarizer was used to avoid the incidence of the linearly polarized light onto the ND piece 138, 348A thereby preventing a difference of excitation intensity along the four NV center axes. The collection of photoluminescence emanating from the ND 348A was carried out using the same objective lens 634. The collected from the ND 348A PL 632 was directed through the dichroic mirror 634 to filter out the shorter-wavelength excitation light from the beam 622, and then focused by a 75 mm focal length achromatic lens 636 on an optical input of the PL-collecting apparatus 640, in which a portion of the collected PL 632 (of about 30%) was reflected to an auxiliary optical imaging system 644 (such as an optical camera) to allow for real-time PL imaging of the single-crystal piece of ND portion of the embodiment of the probe 348A (denoted as “sample” in reference to the “sample mount” in FIG. 6), and while the remaining ˜70% of the collected PL was coupled to a 50 μm core optical fiber connected to an avalanche photodetector, APD such as Excelitas APD (shows as 706 in FIG. 7A), for measurement of power and/or to a spectrometer (not shown) for measuring spectral characteristic(s) of the PL. The overall setup of FIG. 6 was housed on an optical breadboard on the minus-k vibration isolation platform.

Referring now to FIGS. 7A, 7B, and 7C, the TTL pulse output of the APD was counted by a photon counter 710 (Stanford Research SR400). The counter analog output that was proportional to the photoluminescence intensity was connected, 714, to the channel A of Stanford Research SR830 lock-in amplifier 720. The sine-wave output 722 from a signal generator 724 was used to modulate the SynthHD microwave generator 730, operably connected (optionally, through the microwave amplifier 734) with the metallic portion 120 of the probe 100 (see FIG. 1) to operate the embodiment 100 of the probe or with another, auxiliary, external antenna when needed (such as in the case when the process of determining the orientations of NV center(s) of the ND 138, 348A was complemented with the use of external antenna, as discussed in more detail below). The modulation signal output from the signal generator 724 was also fed, 734, into the reference channel of the SR830 lock-in amplifier 720 as a reference signal.

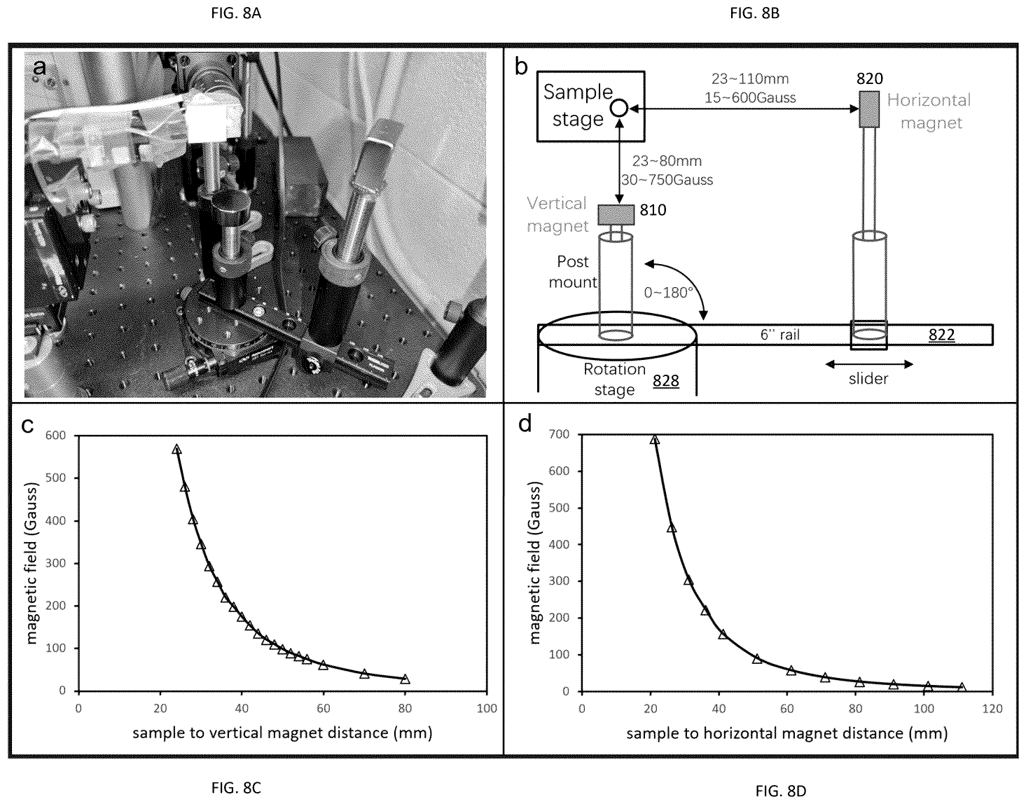

To determine orientation(s) of NV centers of the single-piece ND 348A attached to the apex of the tip of the member 110 of the probe 100, a 3D vector magnet was used to measure magnetic field dependence of the PL produced by the NV center(s). FIG. 8A presents an image of a home-built 3D magnet configuration that includes a combination of two permanent magnets to achieve a strong vector magnetic field, with a corresponding schematic illustrated in FIG. 8B. Here, as shown, two of N52 Neodymium rare-earth magnets 810, 820 were affixed/glued to respective graduated optical posts and mounted in a post-mount. The post-mount supporting the horizonal magnet 820 is fixed to a rail mount slider (RC1) on a 6-inch optical rail 822 (RLA0600) that can be rotated by using a rotation stage. The horizontal magnet 820 could provide a corresponding magnetic field from about 15 to about 600 Gauss by adjusting the distance between the magnet 820 and the sample (ND 348A) from about 23 mm to about 110 mm in different orientations. The post-mount supporting the vertical magnet 810 was positioned at the center of the rotation stage 828. The height of the vertical magnet 810 could be adjusted, thereby providing a corresponding magnetic field from about 30 Gauss to about 750 Gauss. The strength and orientation of the magnetic field(s) was calibrated by a Lakeshore 3-axis gaussmeter. The magnets could be manually adjusted to achieve any desired vector magnetic field strength and orientation within the corresponding range. Non-ferromagnetic screws, posts, and sample stage were used to avoid the magnetization influencing the vector magnetic field distribution. The Earth magnetic field (0.25˜0.65 Gauss, depending on the location) is negligible for the usage, so the magnetic field compensation was not necessary. FIGS. 8C, 8D display the calibrated field strengths as functions of distances between the magnet(s) 810, 820 and the sample (ND 348A).

It is readily understood that the methodology of invention is preferably employed with the use of a piece of ND 348A that is a single-crystal piece of ND. Indeed, to identify the orientation of an NV center of the ND piece 348A attached to the apex of the tip of the cantilevered member 110A of the probe 100 substantially uniquely with respect to the orientation of the carbon lattice of the ND 348A, the presence of a single carbon lattice (in which case the orientation of the NV center would be one of the four possible orientations) is required When multiple lattices are present (as in the case of a polycrystalline ND piece), the determination of definitive relative orientation may become problematic, which in turn leads to the problems with (if not impossibility) of performing the process of quantum sensing).

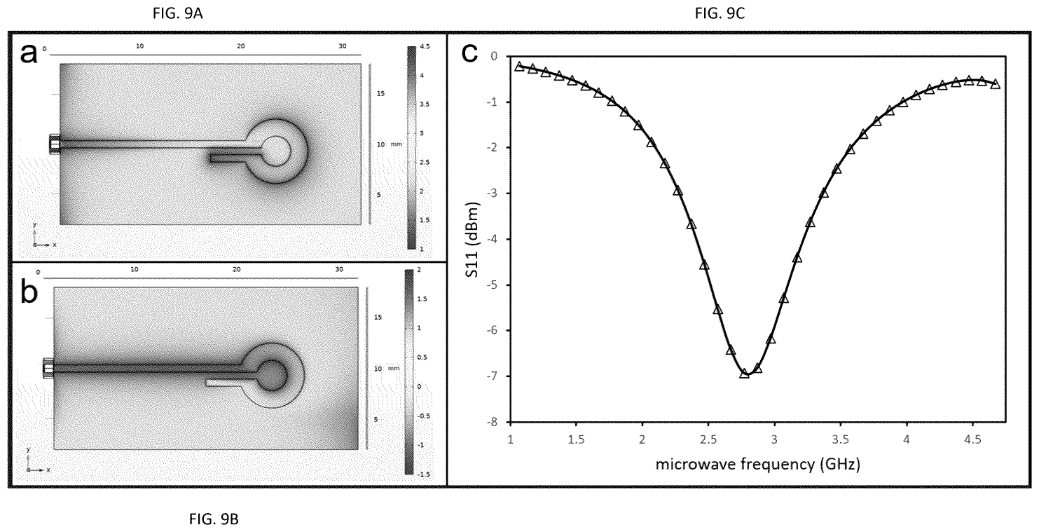

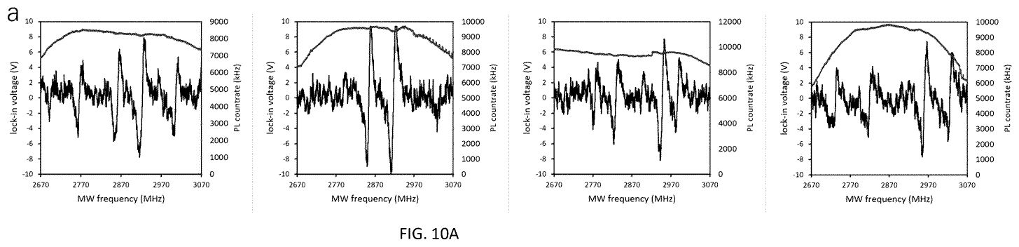

Optionally—but preferably, for the sake of certainty of reliable “pre-calibration” of the embodiment of the probe—the determination of the orientations of the NV center(s) of the ND-portion 138, 348A of the embodiment of the probe could be facilitated with the use of yet another—external to the embodiment of the probe—antenna, as would be understood by a skilled person. In one specific case, to perform ODMR measurements for determining orientations of NV center(s), a loop resonance antenna 756 was designed and fabricated for delivery of a microwave to the NV centers of the ND 138, 348A and, when required, modulation of such microwave. The dimension and geometric parameters of such loop antenna 756 was optimized by performing COMSOL finite element method (FEM) simulation, the results of which are shown in FIGS. 9A, 9B. The S11 parameter (also known as the input reflection coefficient or return loss, which represents the power reflected from the antenna's input port due to an impedance mismatch between the antenna and its connected transmission line) was also simulated and measured (as shown in FIG. 9C), demonstrating that the loop antenna could provide an almost uniform microwave field in about 1×1 mm² area within a large bandwidth having FWHM of more than 1 GHZ, thereby enabling a wide range of scanning and manipulation. Referring again to FIGS. 7A, 7B, when such loop antenna was used for determination of NV centers orientations, a SynthHD USB3 microwave generator 730 controlled by a home-built LabVIEW program was used as the microwave source. The microwave generator 730 was connected to the ZHL-16 W-43-S+high-power amplifier 73 to amplify the microwave signal to a maximum of about 42 dBm (16 W). The resulting microwave could be either frequency-modulated or amplitude-modulated with the external signal generator 724. The signal generator 724 was also connected to the lock-in amplifier as a reference signal of the collected photoluminescence signal, and the microwave signal was further passed on through the coaxial cable 752 to the loop antenna 756 etched into the PCB 758 externally with respect to the location of the embodiment of the probe 100 (in reference to FIG. 7B, both elements 100 and 756 are located behind the shield 760).

As a skilled artisan will readily appreciate, to extract the NV center orientation at least 3 sets of ODMR curves procured under different magnet orientations of a magnetic field (and thus—under different orientations of the used magnets 810, 82) are required. In most situations, only the horizontal magnet 820 was sufficient to provide three different orientations of the magnetic field. The vertical magnet 810 was employed only in some special situations, such as when one NV orientation was perpendicular to the horizontal magnetic field produced by the magnet 820, thereby leading to no shift of the ODMR frequency when changing such horizontal magnetic field.

Both the photoluminescence and lock-in output of photoluminescence referenced by the microwave modulation signal were recorded with the use of a LabVIEW program during the ODMR scanning. As a result of measuring the lock-in signal filtering out the low-frequency noises and increasing the SNR was carried out. A zero-field ODMR curve was first acquired to make sure there was no error in various connections of the overall apparatus and parameters setting. The typical laser power was about 10 mW, the scanning speed was about 1 MHz/s, the lock-in time constant was 3 seconds, the frequency modulation depth was 5 MHz, and the modulation frequency was between 10 and 30 Hz. Once the zero-field ODMR signal from the ND 348A was confirmed, the distance between the horizontal magnet 810 and the ND portion 138, 348A of the probe 100 was adjusted to get around 50 gauss magnetic field strength (which gives a max ODMR peak splitting of 280 MHz). Then, at least 3 sets of ODMR curves under different magnet orientations were measured, and the resonant frequencies in each ODMR curve were extracted by fitting the peaks with differential Lorentz functions.

The algorithm of extracting the resonant frequency of each of the ODMR curve was structured as follows:

The spin Hamiltonian of an NV center in the presence of external magnetic field can be expressed as:

$$\frac{H}{h} = {D}_{0} {S}_{z}^{2} + γ ( {B}_{x} {S}_{x} + {B}_{y} {S}_{y} + {B}_{z} {S}_{z} ) ,$$

where D₀=2870 MHz, γ=2.8 MHz/Gauss. When the transverse magnetic field is smaller than about 100 Gauss, the BₓSₓ+B_{y}S_{y} term in the above expression becomes practically negligible. Only the projection of magnetic field strength on the orientation of the NV axis needs to be considered. Identifying the angle between the magnetic field B vector and the NV symmetry axis as θ, the approximation of the two ODMR peak positions became 2870±2.8 B cos(θ) MHz. For each magnetic field applied, a pair of ODMR peaks for each NV center orientation could be measured. Then, the NV center orientation could be determined on the cone surface formed by the direction of the magnetic field. The cone angle was determined by peak splitting and the strength of applied magnetic field. The above NV energy equation could be used to generate peak positions for an NV center orientation θ and φ by varying the θ and φ from 0 to π and 0 to 2π with a step size of 0.02 rads, respectively, and comparing these theoretical results with experimental peak positions by evaluating the mean square loss between the theoretical peak positions and the experimental peak positions. The θ and φ that generated the peak position closest to the experimental result was taken as the orientation of the NV center.

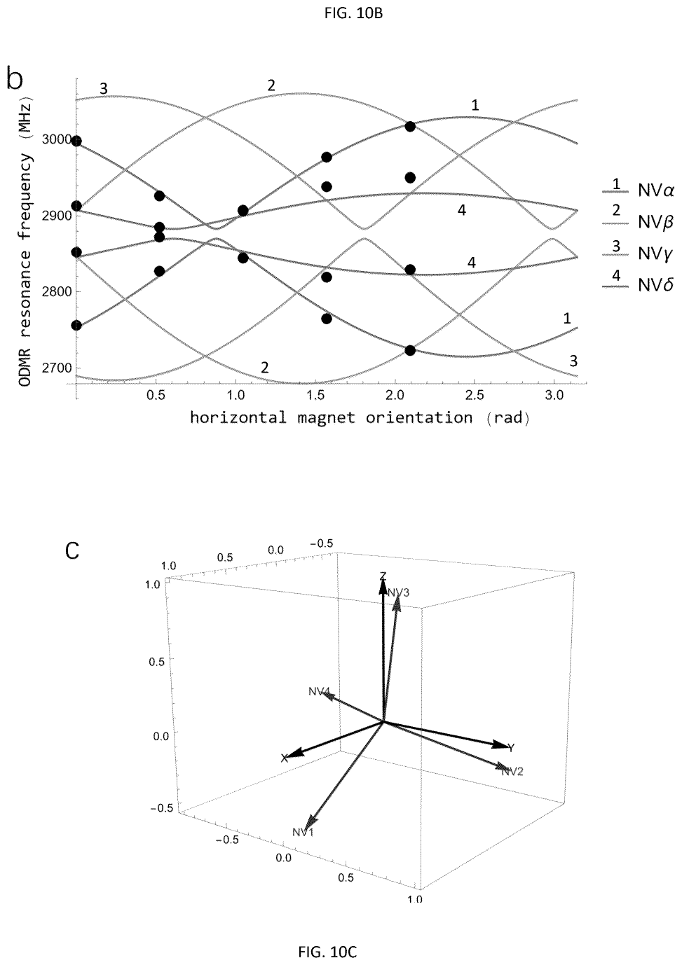

FIGS. 10A, 10B, 10C illustrate one example of determining NV center orientations on the cantilever-based probe using ODMR peaks under different orientations of the applied magnetic field. The depolarizer (of FIG. 6) was removed so only two pairs of excited NV center orientations were shown in ODMR scanning. By using the ODMR peak position measured in the experiment (the black dots in FIG. 10B, the orientation of the NV centers is calculated, and the calculated ODMR resonance frequency of the four NV center orientations with relation to horizontal magnet orientation is shown by colored curves in FIG. 10b. The NV center orientation is calculated to be θ=2.12 rad, φ=0.74 rad. The orientation of the four NV centers is plotted in FIG. 10C in reference to the local system of coordinates (with the z axis being the axis 350 of the tip 114).

### Section 3: Applications of Cantilevered NV Center(s) Scanning Probes Structured According to the Idea of the Invention.

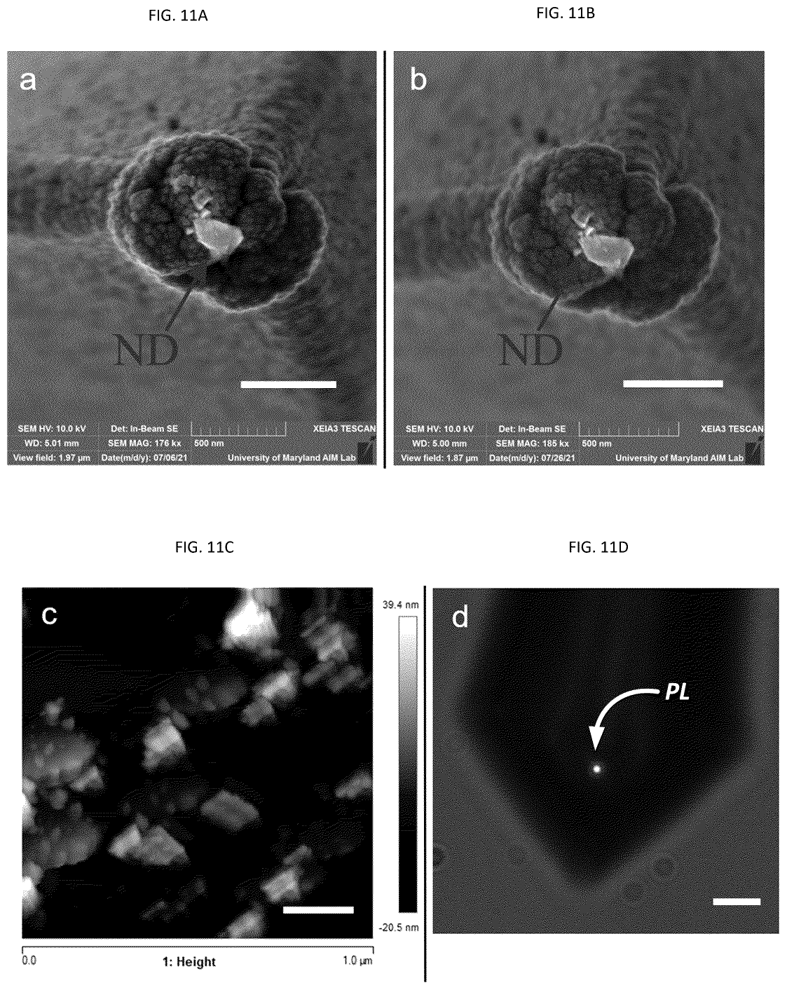

FIG. 11A shows an SEM image of a tip of as-fabricated (according to the embodiment 100) cantilever-based NV centers scanning probe. Once the orientations of NV centers of the single-crystal ND 348A were determined, the fabrication of a cantilever-based NV quantum sensor was completed and ready for use in substantially any commercial or custom-built scanning system—such as, for example, in an system employing the AFM hardware (in one case—a commercially available AFM apparatus)—without any further modifications. The process of quantum sensing with the use of the embodiment of the probe (operating now as a quantum sensor) can then be implemented by applying a microwave signal to the metallization of the probe (120, FIG. 1) to manipulate the NV center spins while scanning the tip 114 with the ND portion 138 over a chosen sample surface. This approach can enable high-sensitivity, non-invasive imaging of magnetic field distributions in quantum magnetic materials, magnetic memory, and spintronic devices through techniques such as relaxometry, electron spin resonance spectroscopy, and magnetic noise spectroscopy with scanning NV centers. In addition, it can be used to detect surface currents and charge distributions, monitor surface chemical reactions, as well as to probe temperature gradients across the sample surface based on quantum properties of NV centers.

Robustness and spatial resolution of using as-fabricated probe for AFM imaging was tested with the use of a Bruker's Dimension AFM equipped with such a probe. FIG. 11B presents the SEM image of same probe as that of FIG. 11A, but after continuous five-hour scanning on a fused silica substrate. Notably, no degradation of as-fabricated probe can be observed. FIG. 11C provides a typical image of a silica substrate, produced with an AFM hardware equipped with the embodiment 100 of the probe, demonstrating the spatial resolution of about 20 nm. FIG. 11D shows emission from the NV center of the ND 348A (bright spot in the image) under optical excitation of the same ND piece.

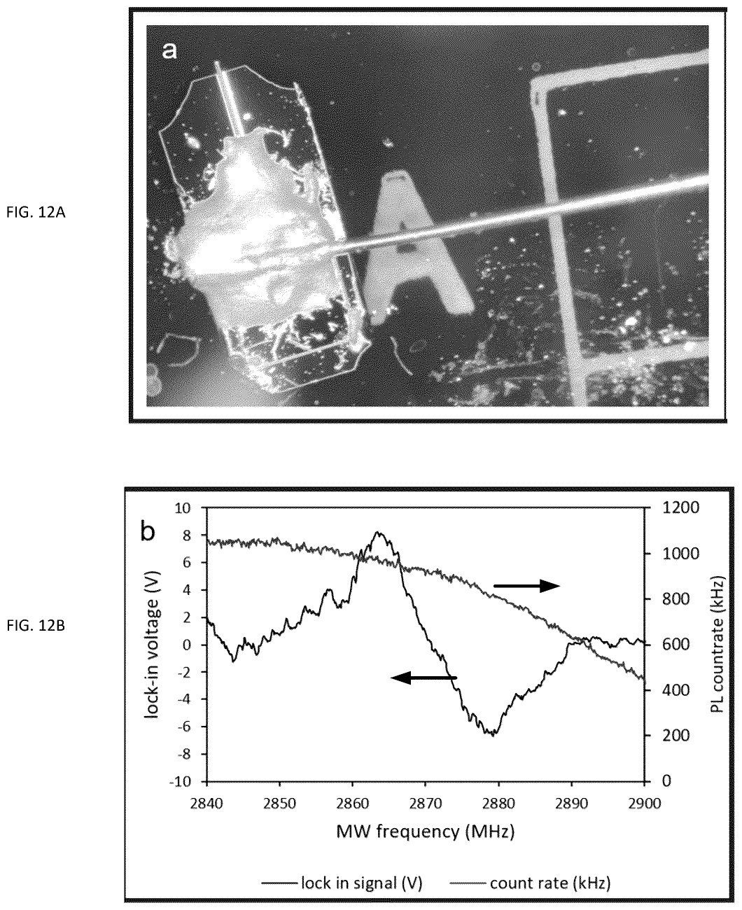

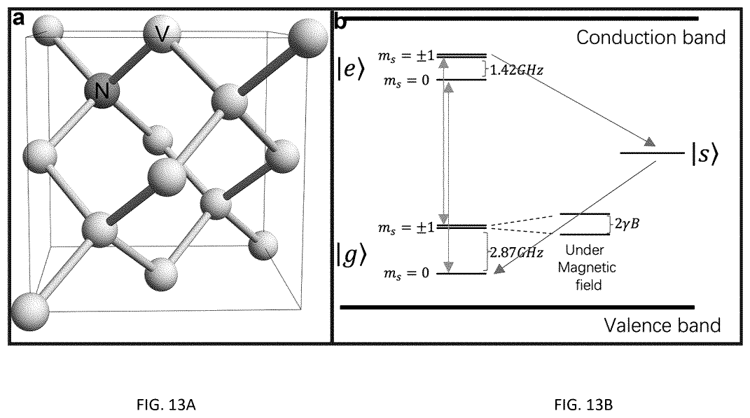

To test the feasibility of ODMR by using Au film over-coated tip 114 of the probe 100 as a microwave antenna, an 18 mm length copper wire was glued to the base of the cantilever to establish electrical contact with gold film by using silver paste (FIG. 12A). FIG. 12B displays the corresponding ODMR curve when 30 dBm microwave power was coupled through the coaxial wire, confirming the quantum sensing capability of the as-fabricated cantilever-based (cantilevered) NV centers probe as a quantum sensor.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. The use of this term in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated may vary within a range defined by an experimental measurement error that is typical when using a measurement method accepted in the art for such purposes. As an example only, a reference to a vector or line or plane being substantially parallel to a reference line or plane is to be construed as such vector or line extending along a direction or axis that is the same as or very close to that of the reference line or plane (with angular deviations from the reference direction or axis that are considered to be practically typical in the art, for example between zero and fifteen degrees, more preferably between zero and ten degrees, even more preferably between zero and 5 degrees, and most preferably between zero and 2 degrees). A term “substantially flexible”, when used in reference to a housing or structural element providing mechanical support for a contraption in question, generally identifies the structural element the flexibility of which is higher than that of the contraption that such structural element is associated with. As another example, the use of the term “substantially flat” in reference to the specified surface implies that such surface may possess a degree of non-flatness and/or roughness that is sized and expressed as commonly understood by a skilled artisan in the specific situation at hand. For example, the terms “approximately” and about”, when used in reference to a numerical value, represent a range of plus or minus 20% with respect to the specified value, more preferably plus or minus 10%, even more preferably plus or minus 5%, most preferably plus or minus 2%.

The term “A and/or B” or a similar term is defined to be interchangeable with the term “at least one of A and B.” The term “image” refers to and is defined as an ordered representation of detector signals corresponding to spatial positions. For example, an image may be an array of values within an electronic memory, or, alternatively, a visual or visually-perceivable image may be formed on a display device such as a video screen or printer.

It is appreciated that operation of an embodiments of the invention may be governed by a processor controlled by instructions stored in a memory. The memory may be random access memory (RAM), read-only memory (ROM), flash memory or any other memory, or combination thereof, suitable for storing control software or other instructions and data. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described example(s) of embodiments, it will be understood by those of ordinary skill in the art that modifications to, and variations of, the illustrated embodiments may be made without departing from the inventive concepts disclosed herein. Accordingly, the invention should not be viewed as being limited to the disclosed embodiment(s).

What is claimed is:

1. An article of manufacture comprising:
a cantilevered probe having a cantilever and a tip at a proximal end thereof, the cantilevered probe structured to operate as a microwave antenna and configured to be operably connected to a microwave generator system.

2. An article of manufacture according to claim 1, wherein the cantilevered probe further comprises a single-crystal piece of nanodiamond (ND) affixed to an apex of the tip.

3. An article of manufacture according to claim 1, configured to modulate a microwave signal produced by the microwave generator system and to couple a modulated microwave signal to the cantilevered probe.

4. An article of manufacture according to claim 1, wherein:
an apex of the tip of the cantilevered probe carries a material containing a source of photoluminescent light; and/or
the tip of the cantilevered probe carries thereon a layer of adhesive containing a dye.

5. An article of manufacture according to claim 4, wherein said material includes a single-crystal diamond material containing a nitrogen vacancy center.

6. An article of manufacture according to claim 1, further comprising:
a first source of light optically coupled with a proximal end of the probe, wherein the article is configured to deliver first light generated by the first source of light to the distal end; and/or
a second source of light, wherein the article is configured to deliver second light generated by the second source of light to a cantilever of the cantilever probe to detect a deflection of the cantilever.

7. An article of manufacture according to claim 1, further comprising:
an optical detection system that includes an optical detector, and
an optical system that is configured
to receive a first optical radiation from a distal end of the cantilever probe to form an image, in said first optical radiation, at a surface of the optical detector and/or a second optical radiation delivered in reflection from a cantilever of the cantilevered probe.

8. An article of manufacture according to claim 1, that includes a sample stage configured to support a target sample in a repositionable spatial relationship with respect to the cantilever probe to enable subjecting the target sample to excitation microwave radiation produced at the cantilever probe.

9. An article of manufacture according to claim 1, comprising a support structure configured to secure a proximal end of the cantilever probe therein.

10. An article of manufacture according to claim 8, comprising a scanning force microscope apparatus configured to accept the cantilever probe therein and to operate with the use the cantilever probe.

11. A method comprising:
with the use of the article of manufacture according to claim 1:
forming an image of a nitrogen vacancy (NV) center contained in a single-crystal piece of nanodiamond (ND) with the use of photoluminescent light produced by the single-crystal piece of ND; and/or
determining an orientation of the NV center in the single-crystal piece of ND.

12. A method according to claim 11, comprising:
assessing an orientation of the center contained in the single-crystal piece of ND that has been affixed to the tip of the cantilever probe, with respect to a chosen axis at least in part by performing the following steps:
step (a): determining a zero-magnetic-field signal representing an optically-detected magnetic resonance of said NV center during a process of detecting a first photoluminescence signal generated at the NV center while modulating a microwave signal applied to the NV center in absence of a magnetic field, wherein the microwave signal is generated at the cantilever probe;
and
step (b): applying at least one of a first magnetic field and a second magnetic field to said NV center with first and second magnets, respectively, that are configured
(i) to change a spatial orientation of at least one of a first vector of the first magnetic field and a second vector the of the second magnetic field and/or
(ii) to vary respective strengths of the first and second magnetic field;
and
collecting a second photoluminescence signal generated at the NV center while modulating the microwave signal applied to the NV center
to determine optically-detected magnetic resonance characteristics of the NV center for said at least one of the first magnetic field and the second magnetic field.

13. A method according to claim 12, further comprising:
repeating said applying and said collecting for multiple orientations of the at least one of the first magnetic field and the second magnetic field applied to the NV center to determine respectively-corresponding multiple optically-detected magnetic resonance characteristics.

14. A method according to claim 11, comprising:
prior to the forming the image and/or the determining the orientation,
affixing the single-piece of the ND to the tip of the probe with the use of an adhesive that includes a dye and that is carried by the tip.

15. A method according to claim 11, comprising:
prior to the forming the image and/or the determining the orientation,
causing an electrically-conducting layer of a tip of the cantilevered probe to become hydrophilic.

16. A method according to claim 11, wherein the article of manufacture includes an optical imaging system, the method further comprising:
substantially spatially aligning, a first optical image formed with the optical imaging system in photoluminescent light emanating from the single-crystal piece of the ND affixed to a tip of the cantilevered probe with a second optical image formed with optical imaging system in optical radiation that is produced by a chemical substance carried by the tip of the cantilever probe.

17. A method according to claim 11, comprising:
operably connecting an electrically-conducting portion of the cantilever probe to the microwave generator;
choosing the single-crystal piece of the ND from a multiplicity of single-crystal pieces of the ND based on characterizing at least NV center contained therein, performed with the use of the cantilever probe at a tip of the probe;
affixing a chosen single-crystal piece of the ND to the tip of the cantilevered probe; and
activating the microwave generator to manipulate a spin of the NV center with a microwave emanating from the electrically-conducting portion of the cantilever probe.

18. A method according to claim 17, wherein the characterizing includes: determining an intensity of photoluminescence produced by the at least one NV center and/or using an auto-correlation measurement.

19. A method according to claim 11, further comprising:
manipulating scanning a spin of the NV center of the single-crystal piece of ND that has been affixed to the tip while scanning the tip over a sample surface.

20. A method according to claim 19, wherein said manipulating includes applying a microwave signal to the single-crystal piece of ND by operating the cantilevered prove as the microwave antenna, and further comprising:
determining at least one of a magnetic field distribution in a sample, an electric charge distribution across the sample surface, a chemical reaction at the sample surface, and a temperature distribution across the sample surface based on detection of a change of properties of the NV center.

21. A computer program product for use on a computer system for characterizing and/or imaging of a color center of a material particle, the computer program product comprising a computer usable tangible non-transitory storage medium having computer readable program code thereon, the computer readable program code including program code for performing steps of the method according to claim 11.

22. A method comprising:
with a cantilevered probe of a scanning force microscope, which probe has been configured to operate as a microwave antenna:
emitting an electromagnetic wave; and
characterizing a piece of a diamond material and/or manipulating a physical characteristic of the piece of the diamond material with the use of said electromagnetic wave.
